(19) United States
(12) Patent Application Publication
(10) Pub. No.: US 2023/0109539 A1
(43) Pub. Date: Apr. 6, 2023

(54) Vehicle Diagnostic System and Method having Specialized Data

(71) Applicant: Robert Bosch GmbH, Stuttgart (DE)

(72) Inventors: Troy Liebl, Owatonna, MN (US); Venkatesh Gorur Krishna Iyengar, Apple Valley, MN (US)

(21) Appl. No.: 17/959,223

(22) Filed: Oct. 3, 2022

Related U.S. Application Data
(60) Provisional application No. 63/252,958, filed on Oct. 6, 2021.

(51) Int. Cl. G07C 5/08; G07C 5/00

(52) U.S. Cl. CPC G07C 5/0808; G07C 5/008

(57) ABSTRACT

A vehicle diagnostic system and method utilizing a plurality of diagnostic data corpuses. A first corpus comprises conventional and well-known diagnostic data useful in a broad range of common service tasks. A second corpus comprises less well-known diagnostic data useful in less common service tasks. One or more specialty corpuses may comprise obscure, protected, or emerging diagnostic data for the last-common tasks specific to particular manufacturers of the vehicle or its components. The second corpus and one or more specialty corpuses may offer access only to users that have acquired sufficient authorization.

### TECHNICAL FIELD

This disclosure relates to the servicing of a vehicle including diagnostic procedures.

### BACKGROUND

Vehicle diagnostic services are a critical component of modern vehicle servicing. It is critical to accurately assess the operational condition of a vehicle prior to performing any service such as maintenance, calibration, or repair. An accurate assessment of the vehicle's condition can guide service personnel to an expedient and proficient performance of the necessary service tasks.

Accurate assessments of the vehicle's condition may require extensive and specialized technical knowledge. Modern vehicles may provide insights to their operational condition utilizing electronic data communication. Electronic data indicating the operational condition of the vehicle may be generated, such as diagnostic codes associated with the vehicle, a component of the vehicle, or one of the vehicle's systems. Additionally, several factors may complicate the diagnostic process and subsequent repairs. Technicians must be able to acquire vehicle operational data from the vehicle as well as vehicle ID data, as different manufacturers may utilize similar or identical operational data or diagnostic codes that have completely distinct meanings in the context of their respective vehicles. Vehicle operational data may differ from vehicle to vehicle, from component to component, and even from year to year of the same vehicle or component thereof. Additionally, the manufacturers may choose to restrict access to some data useful in completing a diagnostic service for reasons of safety, security, or intellectual property. This limited-access data may be desirable because it is for emerging technologies or for a newly-released vehicle, component, or system. This diagnostic service is additionally complicated when accounting for aftermarket components and systems that may behave differently from the stock models. Thus, a comprehensive diagnostic service may require a level of technical know-how that is both broad and deep, and may be expensive to acquire or maintain.

It would therefore be desirable to have a system that provides a technician or other service personnel with guidance and access to a wide range of diagnostic data corresponding to a wide range of vehicle types, vehicle components, and vehicle systems that may be encountered. It may further be advantageous to provide the system in such a way that access to the desired diagnostic data may be accomplished at a reduced cost.

### SUMMARY

A first aspect of this invention is directed to a vehicle diagnostic system having a vehicle communication interface (VCI), a server, and a network access point. The VCI may comprise a VCI processor, VCI memory, and a VCI transceiver. The VCI transceiver may be in data communication with a vehicle subjected to a diagnostic service operation. The network access point may comprise a wireless access point, and provides data communication between the VCI and the server. The server may comprise a server processor, and a server memory. The server memory comprises a server corpus of diagnostic data for use in the diagnostic service operation. The server memory further comprises a dynamically-linked library (DLL) usable by the server processor to interface with the VCI processor in a secure fashion. The server may be operable to initiate communication with one or more specialty servers comprising specialty corpuses of diagnostic information. Some embodiments of the first aspect may additionally include a diagnostic tool having a human-machine interface (HMI) suitable for providing output to a user of the system and suitable for receiving input commands from the user. In another aspect of the invention, the DLL of the server memory may define a J2534 protocol.

Another aspect of this invention is directed to a method of seeking desired vehicle diagnostic data during a diagnostic service operation. The method comprises the steps of establishing data communication between a VCI and a first corpus of diagnostic data. The VCI is operable to seek desired diagnostic data from within the first corpus, and recognize when the desired diagnostic data is not available from the first corpus. In response to determination that the desired diagnostic data is not available, the VCI is operable to automatically initiate contact with one or more different specialty corpuses to seek the desired diagnostic data. Once the one or more specialty corpuses have been searched, the results of the search are provided to the VCI, and the VCI is configured to re-establish contact with the first corpus. The data communication between the VCI and the first corpus may utilize a J2534 protocol. The diagnostic service operation may utilize a membership status of a user associated with the VCI. The membership status may be utilized to controlling access to some or all sub-portions of the server corpus or one or more of the specialty corpuses. Different membership status may be applied to permit different levels of access to the corpuses.

The above aspects of this disclosure and other aspects will be explained in greater detail below with reference to the attached drawings.

### BRIEF DESCRIPTION OF THE DRAWINGS

FIG. 1 is a diagrammatic view of a vehicle diagnostic system.

FIG. 2 is a flowchart illustrating a method of vehicle diagnostic and repair certification.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

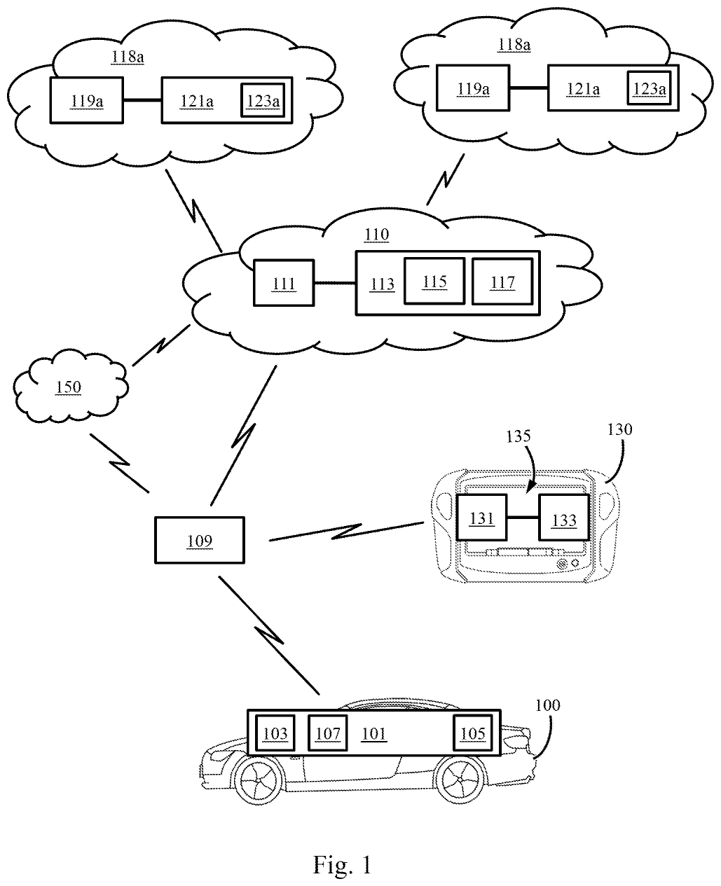

FIG. 1 shows a diagrammatic illustration of a vehicle diagnostic system according to one embodiment of the invention. The vehicle diagnostic system is compatible with a vehicle 100 subject to a service operation. A service operation may comprise a diagnostic service, a maintenance service, a repair service, or some combination thereof. In the teachings herein, the service operation shall be understood to comprise at least a diagnostic service to generate a diagnosis of a subject vehicle, such as vehicle 100, but other embodiments may comprise other or additional combinations of service operations without deviating from the teachings disclosed herein. Vehicle 100 further comprises a vehicle communication interface (VCI) 101. VCI 101 is configured to provide data communication between a processor associated with the vehicle and external devices, including diagnostic devices. This data communication is achieved utilizing component parts of VCI 101, including a VCI processor 103 and a VCI memory 105. VCI 101 further comprises a VCI transceiver 107 that is operable to provide data communication between the VCI 101 and vehicle 100 as well as with other components of the system. Some embodiments may utilize a distinct vehicle transceiver configured to interface with vehicle 100 without deviating from the teachings disclosed herein. VCI transceiver 107 may be operable for data communication using wireless or wired connections, but other embodiments may utilize only a single connection type without deviating from the teachings disclosed herein. In the depicted embodiment, VCI transceiver 107 comprises a single component operable to address incoming and outgoing data communication messages, but other embodiments may comprise a distinct transmitter component and receiver component without deviating from the teachings disclosed herein.

In the depicted embodiment, VCI processor 103 may be in a wired data communication with a controller area network (CAN) bus of vehicle 100 via a vehicle transceiver unit (not shown). Other embodiments may comprise other suitable configurations, such as a wireless connection to the CAN bus, a specialized processor of a head unit within vehicle 100, a detachable dongle conforming to an onboard diagnostic (OBD) protocol, or any other suitable interface for vehicle 100 known to one of ordinary skill in the art without deviating from the teachings disclosed herein.

VCI 101 is operable to generate vehicle data useful for a service operation with respect to vehicle 100. The vehicle data may comprise vehicle ID data identifying features of vehicle 100, such as the make, model, and year of manufacture. The vehicle data may further comprise additional operational data detailing operational behavior of various components of vehicle 100. The operational data may comprise diagnostic codes, each generated diagnostic code associated with a particular condition of vehicle 100. In the depicted embodiment, the diagnostic codes may conform to a diagnostic trouble code (DTC) protocol, but other embodiments may utilize other protocols without deviating from the teachings disclosed herein. It is advantageous for the diagnostic data to further include the vehicle ID data, because similar or identical codes may be utilized by different vehicle manufacturers, and having the associated vehicle ID data advantageously singularly defines the conditions of vehicle 100.

The invention further comprises a network access point in data communication with VCI 101. In the depicted embodiment, VCI 101 is also in data communication with a network access point in the form of a wireless access point (WAP) 109. WAP 109 is itself in data communication with a server 110. In this arrangement, VCI 101 may be in indirect data communication with server 100 via WAP 109.

Server 110 comprises a server processor 111 and a server memory 113. Advantageously, server memory 113 comprises a dynamic-linked library (DLL) 115 compatible with the diagnostic protocol of VCI 101. Critically, the inclusion of the DLL 115 permits server 110 to interface with VCI 101 without requiring any additional hardware or software components to prepare diagnostic data for transmission. Advantageously, this permits VCI 101 to exchange data with server 110 using only WAP 109 and not requiring additional components within the transmission chain. The transmission between server 110 and WAP 109 may be accomplished using a transceiver (not shown), or a combination of distinct transmitter and receiver, without deviating from the teachings disclosed herein. In the depicted embodiment, server 110 may comprise a wireless transceiver configured to be in data communication using a wireless connection, including a wireless connection through the Internet.

The server memory 113 may additionally comprise a server corpus 117 of diagnostic data suitable for use in a diagnosis of the condition of vehicle 100 based on the generated vehicle data. The server corpus 117 may comprise a set of general-use diagnostic data for comparison to the vehicle data. In some embodiments, server corpus 117 may be organized such that different portions thereof are directed to different makes, models, or components of vehicles. Such organization can be utilized to selectively provide data as requested in an efficient manner.

In the depicted embodiment, server processor 111 is in data communication with VCI 101 via a wireless connection. This connection permits an exchange of data and commands between server processor 111 and VCI 101, such as the exchange of the vehicle data and the results of the diagnosis operation of first diagnostic processor 103. If a diagnosis result is not found within the server corpus 117, an error message may be generated. In response to the diagnosis result not being found within server corpus 117, server processor 111 may then initiate contact with external devices that may provide additional or different corpuses of diagnostic data.

In the depicted embodiment, the server corpus 117 may be comprised of a broad set of diagnostic data suitable for general-use in a service facility, but may comprise some limitations. The limitations of the server corpus may comprise incomplete information with respect particular vehicle makes, particular vehicle models, particular years of manufacture for some vehicle models, particular systems within the vehicle, specific DTCs, or proprietary information that is not generally obtainable without special permissions or licenses. In some embodiments, limitations of the server corpus may be related to a membership status of a user associated with VCI 101, wherein active memberships or memberships of a certain tier have direct access to certain portions of the server corpus 117 that other users may not be permitted to access. The server memory 113 may comprise additional information indicating to server processor 111 any known limitations of the server corpus with respect to the diagnostic data stored thereon. This additional information may inform how server processor 111 should proceed in response to determining that the server corpus 117 does not comprise a match for the vehicle data. In response to a vehicle diagnosis not being successfully found within the server corpus 117, server processor 111 may generate a first request to be transmitted to external devices to seek a suitable vehicle diagnosis outside of the server corpus 117.

Server processor 111 is in data communication with a wireless access point (WAP) 109. WAP 109 is further in data communication with additional external devices, and may act as a data waylay for diagnostic device 102 and the external devices. In the depicted embodiment, WAP 109 may optionally be in additional wireless data communication with VCI 101 or other components of vehicle 100, but some embodiments may not comprise such connectivity without deviating from the teachings disclosed herein.

WAP 109 may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art. In some embodiments, WAP 109 may comprise a combination of wireless connectivity to some devices, but wired connectivity to other external devices. In such embodiments, this arrangement may optimize the stability of data communication between WAP 109 and external devices, while also operability of VCI 101 within a facility. In some embodiments, WAP 109 may instead by replaced by an access point comprising only wired connectivity that does not comprise any wireless connectivity without deviating from the teachings disclosed herein. In any embodiments utilizing wired connectivity, the associated access point may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art.

Some or all data within the second corpus may be restricted to a limited access condition having membership requirements. Limited access data may be authorized by a membership status associated with the server processor 111 generating the first request. The membership status is compared to one or more requirements that determine whether some or all of the diagnostic data within the second corpus is accessible to the server processor 111. If the associated membership status of the server processor 111 meets or exceeds the requirement or requirements, the data may be accessed within the second corpus. Membership status may be based upon a subscription payment status, a degree or certification achieved by the user of VCI 101, a professional association with a particular third-party (such as an insurance company), an authorization provided by the operator of the VCI 101, or any other membership status recognized by one of ordinary skill in the art without deviating from the teachings disclosed herein. In the depicted embodiment, a user having insufficient membership status may receive a message from the server 110 indicating their insufficient membership status to access the desired data in the second corpus. This message or another message may additionally offer the user a chance to upgrade their membership status in order to acquire the necessary data. In the depicted embodiment, the membership status may be upgraded using subscription model wherein the user has access to the restricted data for as long as a regular payment is received. In the depicted embodiment, the user may be provided the option for an ad hoc authorization of the membership status upgrade, granting them immediate access to the restricted data under limited terms for a reduced cost compared to a regular ongoing subscription.

In some instances, users may not successfully find the desired vehicle diagnosis in the server corpus 117. For example, the vehicle 100 may comprise a very new or experimental design having associated diagnostic data that is not generally available except from select specialty providers. Such specialty providers may be the original manufacturer of a vehicle, the original manufacturer of a specific vehicle component or system, an entity that holds an exclusive license to provide the particular vehicle diagnosis data, or perhaps a technical support service that specializes in rare or discontinued vehicles or components that are otherwise no longer supported by other service providers. In such instances, the desired vehicle diagnosis associated with the vehicle operational data may not be available even in the membership-restricted portions of server corpus 117. In such instances, server processor 111 may generate a request to one of a number of specialty servers 118 that are associated with a particular specialty provider. Each of specialty servers 118 comprises at least a specialty processor 119 and a specialty memory 121. Each of the specialty memories 121 comprises a specialty corpus 123 having vehicle diagnostic data stored therein. The vehicle diagnostic data stored in a specialty corpus 123 may comprise data that is related to very new, experimental, prototype, or developing vehicles or components. Some specialty corpuses may be comprised in part or in entirety of data that is protected with licenses or other legal restrictions. In practice, each of the specialty corpuses 123 is expected to be accessible only based upon a particular membership status dictated by the operator of the associated specialty server 118.

In practice, server 110 may provide infrequent access to a specialty corpus 123 for multiple VCIs 101 utilizing WAP 109, or perhaps for multiple WAPs 109 located in separate facilities, each of the WAPs 109 providing access to one or VCIs 101. In embodiments having multiple VCIs 101, each request to server 110 will be associated with a particular one of the VCIs 101 that generated it, and the results of the search for a vehicle diagnosis will be returned from the server 110 to the associated VCI 101. In such embodiments, membership status data may be applied to individual users associated with a particular WAP 109 (e.g., a specialist technician with unique certifications compared to other technicians working within the same facility), or membership status may be shared membership statuses that are applied to some or all of the VCIs 101 associated with one or more of WAPs 109 (e.g., a group license enabling multiple technicians working for the same company to access server 110 from multiple locations without impeding their functions because of changes in location).

In the depicted embodiment, shared membership statuses may be offered at a discount compared to the same number of individual membership statuses being applied to each of the VCIs 101 individually. In such embodiments, it is expected that fewer than all associated devices covered by the shared membership status will be requesting the same diagnostic data from the second corpus simultaneously. In practice, a predetermined limited number of users may simultaneously access the same sub-portion of the server corpus 117 under the same shared membership status. If multiple users attempt to access the same sub-portion of the server corpus 117 simultaneously, server processor 111 may generate a queue of users associated with the sub-portion of the corpus. Users may be added to queue as they access the data, and may be removed from the queue upon discontinuing their access. If the queue of users exceeds the predetermined limited number, any users added to the queue after reaching the predetermined limit will be restricted in their access until an earlier user discontinues their access to the data. In some embodiments, server processor 111 may generate a message to users asking if they would like to upgrade or adjust their shared membership status in order to expand the predetermined limit of simultaneous users. The upgrade of adjustment of the shared membership status may take the form of the subscription, ad hoc, or piecemeal access models as disclosed above. In the depicted embodiment, all of these options may be available to the users, but other embodiments may comprise different or additional options or combinations of options without deviating from the teachings disclosed herein.

The membership statuses required to access the specialty corpuses 123 may be arranged in one or more of the ways described above with respect to access of the server corpus 117. In practice, the associated membership status may be associated with the server 110, as well as with any individual VCI 101. In arrangements in which the membership status is associated to the server 110, the server 110 may “lend” its access to one or more of the specialty corpuses to a VCI 101 in exchange for a fee. This fee may be paid using one or more of the subscription, ad hoc, or piecemeal membership status models as described above with respect to the second corpus. Typically, access to the specialty corpuses is expensive. When membership statuses are applied to the server 110, the server 110 may provide indirect access to the specialty corpuses to individual VCIs 101 as part of a membership plan. In such a plan, the operators of the server 110 may pay the expensive costs of continued access to one or more specialty corpuses 123, and offer limited access to the one or more specialty corpuses 123 to users of a VCI 101 in exchange for a lesser cost. In such situations, users of a VCI 101 benefit because they each pay a lesser cost in exchange for only the particular access to the server corpus 117 or specialty corpuses 123 that apply to their work, while the operator of the server 110 benefits because the plurality of VCI 101 users effectively subsidize the costs of the access to the specialty corpuses 123 when their collective lesser fees are larger than the combined fees associated with access to each of the specialty corpuses.

Access to the specialty corpuses 123 or sub-portions thereof may be restricted by membership status associated with an individual VCI 101 in the same manner as applied above with respect to access to the server corpus 117 or sub-portions thereof. Adjustments and upgrades to membership status may be made with respect to access to one or more specialty corpuses 123 in the same manner as applied above with respect to adjustments and upgrades to membership status associated with access to the server corpus 117 as applied above. In the depicted embodiment, each of these access limitations or restrictions may be implemented in combination, but other embodiments may comprise other combinations without deviating from the teachings disclosed herein.

Once a vehicle diagnosis is found in either the server corpus 117 or one of the specialty corpuses 123, the vehicle diagnosis is returned to the VCI 101 associated with transmission of the associated first request. In the event that a vehicle diagnosis cannot be found in the server corpus 117 or any of the specialty corpuses 123, an error indication may be generated and transmitted to the associated VCI 101 that generated the associated first request.

In some embodiments, the vehicle diagnostic system may comprise a diagnostic tool 130 in data communication with VCI 101. The diagnostic tool 130 may be utilized by a user in completion of a service operation. In the depicted embodiment, diagnostic tool 130 may comprise a tablet computing device in wireless data communication with VCI 101, but other embodiments may comprise other configurations without deviating from the teachings disclosed herein. In some such embodiments, diagnostic tool 130 may be embodied as a mobile processing device, a smartphone, a laptop computer, a wearable computing device, a desktop computer, a personal digital assistant (PDA) device, a handheld processor device, a specialized processor device, a system of processors distributed across a network, a system of processors configured in wired or wireless communication, or any other alternative embodiment known to one of ordinary skill in the art.

Diagnostic tool 130 further comprises a tool processor 131, tool memory 133, and a human-machine interface (HMI) 135. HMI 135 comprises outputs for the user to receive information from VCI 100, as well as input for the user to generate commands and requests for the system to utilize in operation. In the depicted embodiment, HMI 135 comprises a combination of inputs including hardware buttons, soft buttons, and a touchscreen display. Other embodiments may utilize additional inputs or other forms of inputs without deviating from the teachings disclosed herein, such as speech input, haptic or pressure input, computer mouse, keyboard, or any other form of processor input device recognized by one of ordinary skill in the art. In the depicted embodiment, HMI 135 comprises a combination of outputs including the touchscreen display and auditory outputs such as speakers. Other embodiments may utilize additional outputs or other forms of outputs without deviating from the teachings disclosed herein, such as external displays, wireless communication devices, audio transducers, haptic feedback components, or other output devices known to one of ordinary skill in the art.

In the depicted embodiment, diagnostic tool 130 may be in indirect data communication with VCI 101 via WAP 109, but other arrangements may comprise different data communication. By way of example, and not limitation, the depicted diagnostic tool 130 may comprise a wired transceiver (not shown) capable of direct wired data communication with VCI 100. Other embodiments of diagnostic tool 130 may comprise different or additional configurations of data communication without deviating from the teachings disclosed herein.

In the depicted embodiment, diagnostic tool 130 may be in regular or continuous communication with VCI 101. In such instances, associated vehicle data may be regularly or continuously updated in response to changes in the conditions of vehicle 100 and provided to a user via HMI 135. Update statuses may be indicative of the current status of vehicle 100 or the operable conditions of VCI 101 or server 110 during service.

For example, the vehicle data may be updated to no longer include a DTC in response to completion of an associated service task. Service tasks may comprise one or more of a maintenance task, repair task, calibration task, diagnostic task, or other service intended to ensure proper and safe operation of the vehicle 100 or one or more of its associated components or systems. As the vehicle data is updated in response to the completion of service tasks, an external party may be contacted with indications of the progress of service tasks desired for completion with respect to vehicle 100. In the depicted embodiment, the external party may comprise a certification server 150 in data communication with server 110. In the depicted embodiment, certification server 150 is in data communication via a wireless connection including the Internet, but other embodiments may comprise data communication between certification server 150 and other components of the system by way of WAP 109. In the depicted embodiment, certification server 150 may be in indirect data communication with the other elements of the system via a connection to WAP 109. In such an embodiment, the connection between certification server 150 and WAP 109 may be a wireless connection comprising the Internet. Other embodiments may comprise other arrangements without deviating from the teachings disclosed herein.

In response to completion of a service task, a VCI 101 may transmit a work record comprising vehicle data, changes in vehicle data, one or more vehicle diagnoses, or additional data to the certification server 150 for review of service task. The additional data may comprise work logs, schematics, image data, audio data, or video data depicting the operational condition of vehicle 100 before and after completion of a service task associated with a vehicle diagnosis. In the depicted embodiment, the additional data may additionally depict the operational condition of vehicle 100 at one or more stages during the service task completion without deviating from the teachings disclosed herein. Once the work record has been transmitted to the certification server 150, the work record may be reviewed. The review of the work record may be accomplished by a human technical expert or may be perform autonomously by a processor comparing the vehicle data generated before and after the completion of the associated service task. If the review of the work record is completed and the work is deemed satisfactory, the certification server 150 generates a certification indicator documenting successful completion of the associated service task.

Certification server 150 may generate one or more of a number of distinct certification indicators, each of the certification indicators associated with a particular service task. A repair certification indicator indicates successful completion of a repair task restoring a proper functional operation to the vehicle, a component of the vehicle, or a system of the vehicle. A maintenance certification indicator indicates successful completion of a maintenance task preserving proper functional operation to the vehicle, a component of the vehicle, or a system of the vehicle. A calibration certification indicator indicates successful completion of a calibration service task restoring or preserving proper functional operation to a component of the vehicle or a system of the vehicle. A diagnostic certification indicator indicates successful completion of a diagnostic service task confirming the current functional operation of the vehicle, a component of the vehicle, or a system of the vehicle. A safety certification indicator indicates successful completion of a service task associated with a safety function of the vehicle. A legal certification indicator indicates successful completion of a service task associated with a function of the vehicle that is mandated by a government for legal operation of the vehicle. Other certification indicators may be utilized instead of, or in combination with, one or more of these listed certification indicators without deviating from the teachings disclosed herein.

Once generated, the one or more certification indicators may be transmitted from certification server 150 to VCI 101. The one or more certification indicators may be used to document the operational status and service history of vehicle 100. The operational status and service history of the vehicle 100 may be stored in a memory, such as VCI memory 105, or any other memory without deviating from the teachings disclosed herein. The certification indicators may be used by local governments to document that vehicle 100 meets the criteria for an emissions check, safety check, or other functional assessment of the vehicle necessary for legal operation on public roads. The certification indicators may be used by insurance companies to document completion of service tasks prior to transferring payment to service personnel working on vehicle 100. The certification indicators may be collected into a vehicle history useful to a person interested in selling or buying vehicle 100. These instances are listed by way of example, and not limitation, and other utilizations of the certification indicators may be realized without deviating from the teachings disclosed herein.

Transmission of the vehicle data, vehicle diagnoses, work reports, and other data between elements of the vehicle diagnostic system may comprise large data files containing potentially sensitive information. For this reason, transmission of this data may be realized utilizing specialized data protocols designed specifically for the transmission of these combinations of data. In the depicted embodiment, the vehicle diagnostic system may utilize data communication that conforms to a J2534 protocol. A J2534 protocol utilizes a proprietary formatting of data that optimizes packet size and also encrypts the data to help preserve confidentiality of the data within the transmission. A J2534 protocol may be specially-adapted to optimize the seeking and transmission of vehicle diagnosis data within the server corpus, second corpus, or one or more of the specialty corpuses comprised of such data. In the depicted embodiment, a J2534 protocol may be utilized for all transmissions between VCI the data communication between the VCI and the specialty server utilizing a network access point and a communication protocol defined by a dynamically linked library (DLL) accessible to the diagnostic server 101 and WAP 109, WAP 109 and diagnostic server 110, diagnostic server 110 and any of specialty servers 118, or WAP 109 and certification server 150. In the depicted embodiment, a J2534 protocol may be utilized in at least some transmissions between diagnostic tool 130 and VCI 101. In some embodiments, the system may permit users to optionally utilize a J2534 protocol. Optional utilization of a J2534 protocol may advantageously enhance compatibility with older or specialty devices in data communication with one or more elements of the vehicle diagnostic system. In some embodiments, different exchanges of data within the system may utilize different transmission protocols in combination without deviating from the teachings disclosed herein.

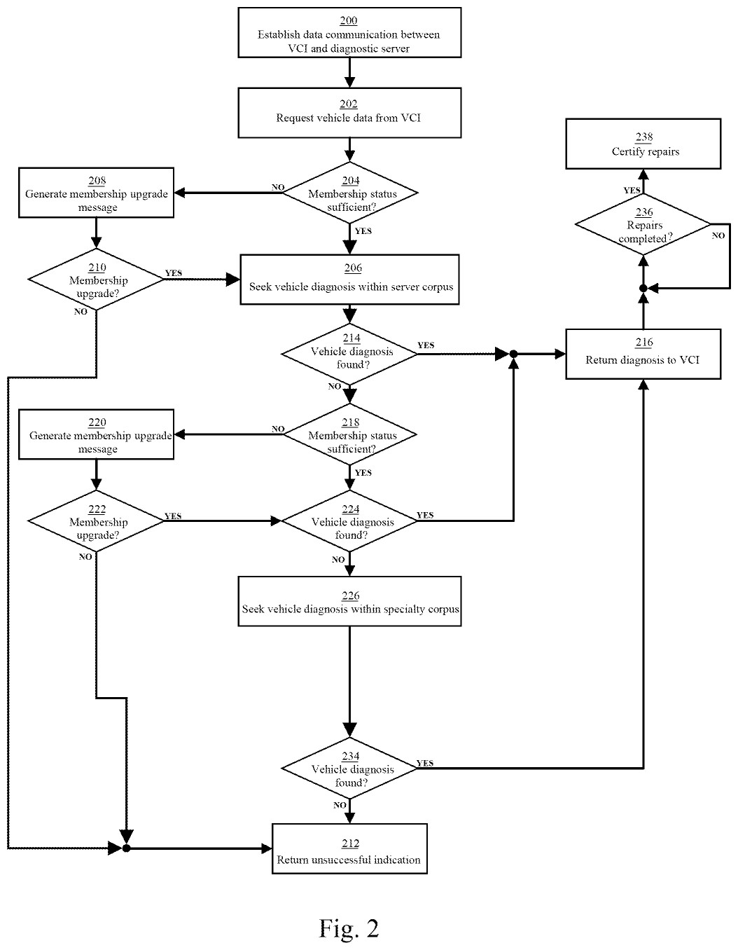

FIG. 2 is a flowchart illustrating a method of operating a vehicle diagnostic system. The depicted method may be performed using one or more processors. In some embodiments, the method may described as a series of processor-executable instructions stored upon a non-transitory computer-readable storage medium that, when ready by a processor, cause the processor to perform the steps of the method described herein. In the depicted embodiment, the method generates a vehicle diagnosis for a vehicle having a vehicle communication interface (VCI) operable for data communication with the system performing the method. In the depicted embodiment, the method may be performed by the vehicle diagnostic system depicted in FIG. 1, but other implementations may be realized without deviating from the teachings disclosed herein.

The method therefore begins at step 200, wherein data communication is established between a VCI and a diagnostic server having a server processor. The server processor may be embodied within a computing device, but other embodiments may comprise other implementations without deviating from the teachings disclosed herein. Data communication may be established using a wireless connection or a wired connection without deviating from the teachings disclosed herein. After data communication is established between the server processor and the VCI, the method proceeds to step 202, where vehicle data is requested from the VCI. The vehicle data requested provides operational data indicating the operational state of the vehicle, as well as vehicle ID data. The operational data may comprise diagnostic codes such as diagnostic trouble codes (DTCs) that correspond to specific operational conditions of the vehicle, a component of the vehicle, or a system of the vehicle. The vehicle indicates identifying information of the vehicle, such as the vehicle's make, model, and year of manufacture. The vehicle ID data may additionally provide identifying data for aftermarket modifications or other customizations of the vehicle, the vehicle's components, or the vehicle's systems.

The first diagnostic processor is associated with a first corpus of vehicle diagnoses. The vehicle data from the VCI may be compared to the contents of the first corpus to seek a vehicle diagnosis with the first corpus. In the depicted embodiment, at least some sub-portions of the first corpus may comprise limited access portions requiring authorization tied to a membership status of the user. Prior to comparing the vehicle data to the second corpus, a membership status of the associated user is checked at step 204 to determine if the user holds a sufficient status to access the second corpus or requisite sub-portions thereof. If the membership status is sufficient, the method proceeds to step 206, where the vehicle diagnosis is sought within the server corpus. If the user does not have sufficient membership status, a message may be generated and returned to the user indicating such at step 208. The system may additionally offer an opportunity for the user to upgrade their membership status at step 210. Membership upgrades may be accomplished according to any authorization method known in the art, such as those disclosed above in FIG. 1 with respect to access to server corpus 117 or a specialty corpus 123. Other embodiments may comprise other authorization methods without deviating from the teachings disclosed herein.

If the user declines to upgrade their membership status, the method proceeds to step 212 and generates an indication that the diagnostic method returned in an unsuccessful result. In this instance, the indication may specify that the diagnosis was not obtained because the user is not authorized to access the additional information within the second corpus. As depicted, the method terminates upon reaching step 212. In the depicted embodiment, steps 204, 208, and 210 form a first membership loop that is utilized to address an insufficient membership status to access the server corpus. In the depicted embodiment, the first membership loop is initiated after the step 202 when the system first initiates a request from the VCI. Other embodiments may instead initiate the first membership loop prior to initiating contact with the server corpus after step 206 without deviating from the teachings disclosed herein. Other embodiments may optionally omit the first membership loop of the method without deviating from the teachings disclosed herein.

The method proceeds to determine if a match for the vehicle diagnosis is found within the server corpus at step 214. If a match is found in step 214, the method may proceed to step 216 and return the vehicle diagnosis to the user for output. The output may have a visual component, audio component, video component, haptic component, or some combination thereof for output to the user via a human machine interface (HMI). The user may interact with the HMI to determine the vehicle diagnoses that are applicable to the vehicle in order to successfully complete a service action.

If a vehicle diagnosis is not found in step 214, the method instead proceeds to additional steps where a vehicle diagnosis is sought from a second, specialty corpus. In the depicted embodiment, the vehicle data is utilized to seek a vehicle diagnosis in a specialty corpus having at least a sub-portion thereof that is distinct from the contents of the server corpus. In the depicted embodiment, at least some sub-portions of the specialty corpus may comprise limited access portions requiring authorization tied to a membership status of the user. Prior to comparing the vehicle data to the second corpus, a membership status of the associated user is checked at step 218 to determine if the user holds a sufficient status to access the specialty corpus or requisite sub-portions thereof. If the user does not have sufficient membership status, a message may be generated and returned to the user indicating such at step 220. The system may additionally offer an opportunity for the user to upgrade their membership status at step 222. Membership upgrades may be accomplished according to any authorization method known in the art, such as those disclosed above in FIG. 1 with respect to access to server corpus 117 or a specialty corpus 123. Other embodiments may comprise other authorization methods without deviating from the teachings disclosed herein.

If the user declines to upgrade their membership status, the method proceeds to step 212 and generates an indication that the diagnostic method returned in an unsuccessful result. In this instance, the indication may specify that the diagnosis was not obtained because the user is not authorized to access the additional information within the second corpus. Otherwise, the method proceeds to step 234 and a vehicle diagnosis is sought within the specialty corpus. As depicted, the method terminates upon reaching step 212. In the depicted embodiment, steps 218, 220, and 222 form a second membership loop that is utilized to address an insufficient membership status to access the specialty corpus. In the depicted embodiment, the second membership loop is initiated after the step 214 when the system recognizes that the server corpus does not comprise an appropriate vehicle diagnosis. Other embodiments may instead initiate the second membership loop prior to initiating contact with the second corpus at step 226 without deviating from the teachings disclosed herein. Other embodiments may optionally omit the second membership loop of the method without deviating from the teachings disclosed herein.

If the user has or acquires sufficient membership status to access the specialty corpus, the method proceeds to step 234, where the contents of specialty corpus are searched for a suitable vehicle diagnosis. If a suitable diagnosis is found, the method proceeds to step 216, where the vehicle diagnosis is returned to the user.

If a suitable diagnosis is still not found in step 234, the method proceeds to step 212 and generates an indication that the diagnostic method was unsuccessful, such as an error code. In the depicted embodiment, the error code may indicate that the diagnostic service operation was unsuccessful because the vehicle data cannot be accommodated by the contents of the server corpus and specialty corpus in combination. As depicted, the method terminates upon reaching step 212.

In the depicted embodiment, the method is depicted with respect to a single specialty corpus associated with steps 226. In some embodiments, multiple specialty corpuses may be available for consideration, each of the specialty corpuses having a membership status requirements. In such embodiments, each of the specialty corpuses may have a unique membership status requirement for access, or some or all of the specialty corpuses may share a membership status requirement without deviating from the teachings disclosed herein. In embodiments having a plurality of specialty corpuses, selection of one or more specialty corpuses that may comprise appropriate diagnostic data at step 226 may be aided by analysis of the vehicle data.

In some embodiments, the method may terminate upon reaching step 216. In other embodiments such as the depicted embodiment, the method may proceed to additional steps. In the depicted embodiment, after the return of the vehicle diagnosis to the VCI at step 216, the method may continue to step 236 where the vehicle data is updated and monitored while service tasks for the vehicle are performed by a user of the diagnostic device. Upon completion of a service task, the vehicle data may be updated, and step 234 may be initiated to determine if the vehicle data indicates any remaining repairs or service tasks are required for the vehicle. If the updated vehicle data still comprises additional need for service tasks, the method returns to step 236 to perform another check after another update of the vehicle data in response to completion of an additional service task. If no additional service tasks are warranted, the method may proceed to step 238 where a certification of the completion of the service tasks may be generated. In the depicted embodiment, the method terminates upon reaching step 238. In other embodiments, steps 236 and 238 may be optional or omitted without deviating from the teachings of the method disclosed herein.

The certification generated at step 238 may be utilized by the user or external entities for reasons such as the reasons disclosed above with respect to certification server 150 (see FIG. 1). Other certification processes or results may be utilized in addition to, in combination with, or instead of those disclosed above without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A vehicle diagnostic system comprising:
a vehicle communication interface (VCI) having
a VCI processor,
a VCI memory in data communication with the VCI processor and storing thereon a first corpus of vehicle diagnostic data,
a VCI transceiver, and
a vehicle transceiver configured to be in data communication with a vehicle processor associated with a vehicle;
a server having
a server processor, and
a server memory in data communication with the server processor and storing thereon a second corpus of diagnostic data and a dynamic linked library (DLL) defining a communication protocol used by the VCI; and
a network access point operable to be in data communication with the VCI and the server,
wherein the VCI processor is operable to detect when a vehicle diagnostic operation requires diagnostic data not found within the first corpus, and initiate data communication with the server via the network access point to access the second corpus.

2. The vehicle diagnostic system of claim 1, wherein the communication protocol defined by the DLL comprises a J2534 protocol.

3. The vehicle diagnostic system of claim 1, further comprising:
a specialty server having
a specialty processor operable for data communication with the server processor, and
a specialty memory in data communication with the specialty processor, the specialty memory storing thereon a third corpus of diagnostic data,
wherein the server processor is operable to detect when a vehicle diagnostic operation requires diagnostic data not found within the second corpus, and initiate data communication with the specialty server to access the third corpus.

4. The vehicle diagnostic system of claim 1, wherein the VCI transceiver comprises a wireless transceiver and a wired transceiver.

5. The vehicle diagnostic system of claim 1, further comprising a human-machine interface (HMI) operable for data communication with the VCI.

6. The vehicle diagnostic system of claim 5, wherein the VCI transceiver comprises a wired transceiver, and the HMI is in data communication with the VCI via the wired transceiver.

7. The vehicle diagnostic system of claim !, wherein the VCI transceiver comprises a wireless transceiver and the network access point comprises a wireless access point, and the data communication between the VCI and the network access point utilizes the wireless transceiver.

8. The vehicle diagnostic system of claim 7, further comprising a human-machine interface (HMI) operable for data communication with the VCI.

9. The vehicle diagnostic system of claim 8, wherein the VCI transceiver comprises a wired transceiver, and the data communication between the HMI and the VCI utilizes the wired transceiver.

10. The vehicle diagnostic system of claim 1, further comprising a human-machine interface (HMI) operable for data communication with the VCI.

11. The vehicle diagnostic system of claim 10, wherein the HMI comprises a tablet computer.

12. A method of seeking desired vehicle diagnostic data during a diagnostic operation of a vehicle communication interface (VCI) associated with a vehicle, the method comprising:
establishing data communication between the VCI and a first corpus of vehicle diagnostic data, the data communication between the VCI and the first corpus utilizing a network access point and a communication protocol defined by a dynamically linked library (DLL) accessible to the diagnostic server;
requesting the desired vehicle diagnostic data from the first corpus;
discontinuing data communication between the VCI and the first corpus in response to the first corpus lacking the desired vehicle diagnostic data;
establishing data communication between the VCI and a specialty server comprising a second corpus of diagnostic data;
requesting the desired vehicle diagnostic data from the second corpus;
discontinuing data communication between the VCI and the second corpus; and
establishing data communication between the VCI and the first corpus after the data communication between the VCI and the second corpus has been discontinued,
wherein the data communication between the network access point and the diagnostic server comprises an Internet connection.

13. The method of claim 12, wherein the communication protocol between the VCI and the diagnostic server comprises a J2534 protocol.

14. The method of claim 12, further comprising returning an error code to the VCI prior to the discontinuing of data communication between the VCI and the second corpus in response to the second corpus lacking the desired vehicle diagnostic data.

15. The method of claim 12, data communication between the VCI and the first corpus comprises a wired connection and the data communication between the VCI and the network access point comprises a wireless connection.

16. A vehicle diagnostic system comprising:
a vehicle communication interface (VCI) having
a VCI processor,
a VCI memory in data communication with the VCI processor,
a VCI transceiver, and
a vehicle transceiver configured to be in data communication with a vehicle processor associated with a vehicle;
an electronic diagnostic tool having
a tool processor,
a tool memory in data communication with the local processor and having stored thereon a first corpus of vehicle diagnostic data, and
a tool transceiver operable to be in data communication with the VCI transceiver;
a server having
a server processor,
a server memory in data communication with the server processor and storing thereon a second corpus of diagnostic data and a dynamic linked library (DLL) defining a communication protocol used by the VCI, and
a server transceiver;
a network access point operable to be in data communication with the VCI and the server; and
wherein the VCI processor is operable to detect when a vehicle diagnostic operation requires diagnostic data not found within the first corpus, and initiate data communication with the server via the network access point to access the second corpus, and wherein data communication between the tool transceiver and the VCI transceiver comprises a wired data connection.

17. The vehicle diagnostic system of claim 16, wherein the communication protocol defined by the DLL comprises a J2534 protocol.

18. The vehicle diagnostic system of claim 16, wherein the electronic diagnostic tool comprises a human-machine interface operable for data communication with the VCI.
